(19) United States
(12) Patent Application Publication
(10) Pub. No.: US 2007/0215433 A1
(43) Pub. Date: Sep. 20, 2007

(54) Partitioned vending machine

(75) Inventors: Bryan M. Logan, Rochester, MN (US); Terrence T. Nixa, Rochester, MN (US); Bradley N. Voigt, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/377,154

(22) Filed: Mar. 16, 2006

(51) Int. Cl. G07F 7/00

(52) U.S. Cl. 194/209

(57) ABSTRACT

A partitioned vending machine including: a user interface portion for receiving an input from a user; an insert for dispensing a product; a plurality of compartments designed to receive the insert; and a communications module for allowing communications with the partitioned vending machine.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This invention relates to vending machines and particularly to partitioned vending machines designed to support multiple sellers.

2. Description of Background

Vending machines are becoming a more popular form of selling a wide range of items. In recent years, more expensive items have become common in vending machines, such as iPods™, digital cameras, and the like. Similar to self-checkout machines, vending machines allow consumers to obtain items quickly and provide a reduction in overhead for a retailer. Currently, if a retailer desires to enter into the business of selling products from a vending machine, he/she must purchase a vending machine and find a suitable location for the vending machine or rent an entire vending machine. Some retailers may not require an entire vending machine, particularly if the retailer desires to sell only one or two items in the vending machine.

Accordingly, what is needed is a vending machine that can be partitioned to support multiple sellers in the same machine.

### SUMMARY

The shortcomings of the prior art are overcome and additional advantages are provided through the provision of a partitioned vending machine.

Exemplary embodiments include a partitioned vending machine including: a user interface portion for receiving an input from a user; a plurality of compartments designed to receive an insert for dispensing a product; and a communications module for allowing communications with the partitioned vending machine.

Exemplary embodiments also include a partitioned vending machine including: a user interface including: a card reader; a cash receiver/dispenser; a keypad; and a display; a plurality of compartments designed to receive an insert for dispensing a product; and a communications module for allowing communications with the partitioned vending machine wherein the insert receives power from the partitioned vending machine.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that allows multiple retailers to use a single vending machine.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a partitioned vending machine in accordance with exemplary embodiments; and

FIG. 2 illustrates one example of a user interface portion of a partitioned vending machine.

The detailed description explains the preferred embodiments of the invention, together with advantages and features, by way of example with reference to the drawings.

### DETAILED DESCRIPTION

In exemplary embodiments, a partitioned vending machine is configured in such a way that two or more retailers are able to sell products from the vending machine. Additionally, the retailers' use of the partitioned vending machine are restricted such that the retailers are prevented from interfering with the products of the other retailers. For example, the retailers are able to load their goods into their rented spaces in the partitioned vending machine, but are not able to access other renter's spaces. In exemplary embodiments, the rented space in the partitioned vending machine can be customized according to the individual needs of each retailer. The owner of the partitioned vending machine may be responsible for collecting and distributing the revenue generated by the partitioned vending machine to the retailers who rent space in the machine. In exemplary embodiments, the owner of the partitioned vending machine rents out spaces in the partitioned vending machine and does not refill the merchandise sold in the vending machine.

One advantage of the partitioned vending machine is that a single vending machine can support multiple sellers. In exemplary embodiments, the combined rent of all renters of space in the partitioned vending machine may exceed the revenue generated by renting an entire vending machine out to a single renter. An owner of a partitioned vending machine in a location that requires a high rent for the placement of the partitioned vending machine may be able to pass on the high cost of rent to each of the retailers. Another advantage of the partitioned vending machine is the reduced cost of renting a space for a retailer. For example, while some retailers may balk at renting an entire machine for $100, they may be more comfortable with renting a single compartment of a partitioned vending machine for $12. In this example, the owner of the partitioned vending machine may be able to collect $144 in rent if all twelve compartments are rented, as opposed to the $100 that they would be able to receive from the rental of the entire vending machine to a single retailer.

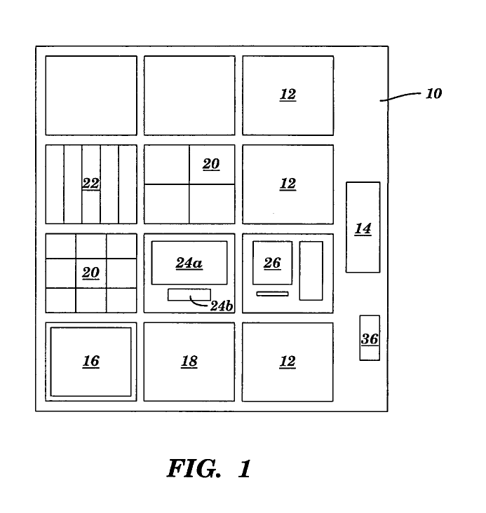

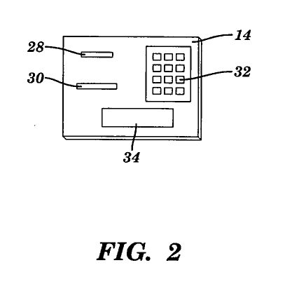

Turning now to the drawings in greater detail, it will be seen that in FIG. 1 there is a partitioned vending machine 10 that includes a plurality of compartments 12, each of which can be rented to a retailer. The partitioned vending machine 10 also includes a user interface portion 14, described herein in further detail with reference to FIG. 2. In exemplary embodiments, each compartment 12 can be configured to hold an insert 16, which is customized to the retailer's merchandise. FIG. 1 depicts several different inserts 16 that are configured to dispense various products. In exemplary embodiments, the partitioned vending machine 10 includes a communications module 36 that allows the partitioned vending machine 10 to communicate over a communications network with the owner of the partitioned vending machine 10 or a retailer renting space in the partitioned vending machine 10. The communications module 36 may include, but is not limited to, a modem, a network interface card, a wireless communications device, or the like. Additionally, the communications network may include, but is not limited to, a plain old telephone network, an Ethernet network, the Internet, a wireless network, or the like.

In one embodiment, the insert 16 may be configured to dispense a single large item. For example, insert 18 may simply have a door on the front of the insert 18 that allows a buyer to open the insert 18 and remove an item. The retailer may reload the item by logging into the partitioned vending machine 10, opening the door, and placing a new item into the insert 18. In another embodiment, the insert 16 may be configured to dispense multiple smaller items. For example, insert 20 may utilize one or more doors on the front of the insert 20 that allows a buyer to open a portion of the insert 20 and remove an item. In this example, when a retailer logs into the partitioned vending machine 10, all the doors for the retailer's insert 20 will be unlocked so he/she may replenish the products. In yet another embodiment, the insert 16 may be configured to dispense books. For example, the insert 22 may include several slots each of which is suitable for holding a book, the slot can tilt forward and the book can be removed.

In a further embodiment, the insert 16 may be configured to dispense small items such as gum or a roll of candy. For example, insert 24 may include a display portion 24a and a dispensing portion 24b. The dispensing portion 24b is where the product will be dispensed to the customer and the display portion 24a is used to display the available products. In exemplary embodiment, a buyer will utilize the interface portion 14 to key in his/her choice and receive the desired product. A retailer may refill the insert 24 by opening the front of the insert 24, giving the retailer access to the rented space. In another embodiment, the insert 16 may be configured to dispense digital items. For example, insert 26 may contain a blank compact disc and allow the user to select a compact disc to burn-on-the-fly. Since the user interaction is more complex than the user interface portion 14 can handle, the insert 26 may contain a special user interface.

Turning now to FIG. 2, a user interface portion 14 of a partitioned vending machine 10 is depicted. The user interface portion 14 includes a card reader 28, a cash receiver/dispenser 30, a keypad 32, and a display 34. The card reader 28 may be used for several purposes including accepting payment from a credit card, a debit card, or a gift card. In exemplary embodiments, when a debit card is used to pay for an item the keypad 32 may be used to accept the card holders Personal Identification Number (PIN). Additionally, the keypad 32 can be used to make a selection of a desired item, or for other user-input. Furthermore, the retailer may use the keypad 32 to adjust prices of their products while at the partitioned vending machine 10. The retailer may use the card reader 28 to log into the partitioned vending machine 10 and access a compartment 12. For example, a retailer may have an access card that once inserted into the card reader automatically opens the retailer's rented compartments 12. The cash receiver/dispenser 30 is used to receive and dispense currency including coins and/or paper money. The display 34 is used to by the partitioned vending machine 10 to communicate with users. The display 34 can include, but is not limited to, a liquid crystal display, a light emitting diode display, an electroluminescent display, or the like.

In an exemplary embodiment, a single partitioned vending machine 10 can be used to sell a plurality of items including anything from candy bars to compact discs. The partitioned vending machine 10 includes several compartments 12 that are designed to receive customizable pluggable modules, or inserts 16, that receive power and authorization from the partitioned vending machine 10. The individual components 12 and/or inserts 16 may contain their own heating or cooling mechanisms. In one exemplary embodiment, the partitioned vending machine 10 may include a shared cooling unit that could be used to cool the compartments 12 and/or inserts 16 that require cooling.

The inserts 16 can be easily removed from the compartments 12 and replaced by the renter of the compartment 12. For example, the renter may log into and instruct the partitioned vending machine 10 to release the insert 16, which would cause locks behind the insert 16 to disengage and release the insert 16. The entire insert 16 can then be removed and replaced with a new one that is locked into place. While it is more likely that the owner of the machine would simply open the machine to replace it on behalf of the renter, it could be possible for the renter to simply buy an insert 16 that conforms to the compartment 12 and use it without having to have the owner of the partitioned vending machine 10 present. In one embodiment, the inserts 16 are designed to have a standardized interface and dimensions to facilitate their modular use with the compartments 12 of the partitioned vending machine 10. For example, a user may purchase a plurality of inserts 16 with varying product configurations that may be used interchangeably with any compartment 12 of several partitioned vending machines 10.

In a particular embodiment, the partitioned vending machine 10 may have a web interface where retailers can log into the partitioned vending machine 10 to check the status of their items and to adjust the price of their items. The retailer would also be able to configure any settings that are unique to their insert 16 (such as temperature, digital music files, etc). Additionally, the owner of the machine could log in via a web interface to configure individual ownership of compartments 12. The configuration interface itself would have an API written so the insert's 16 individual configurations could be stored in RAM in the insert 16. When a user selects an insert 16, the partitioned vending machine 10 will read the configuration RAM and present that screen to the user. This allows the inserts 16 to be truly modular without requiring the partitioned vending machine 10 to know anything about them.

In exemplary embodiments, the owner of the partitioned vending machine 10 will be the only person to have physical access to the portion of the partitioned vending machine 10 that contains the money received. The partitioned vending machine 10 keeps tracks of the sales corresponding to each compartment 12 and the renters are each paid accordingly. In one embodiment, the renters may be given the revenue from their sales electronically. The partitioned vending machine 10 could also be configured to subtract a commission from the sales and remit the commission to the owner of the machine. Additionally, the partitioned vending machine 10 may be configured to send notification to the retailers or owner. The retailer may use the web interface to set up custom preferences for what events the user wishes to be notified of and what manner of notifications they wish to receive. For example, the retailer may desire to be notified via a Short Message Service (SMS) that their product inventory has dropped below a pre-determined level. The partitioned vending machine 10 may be capable of communicating alerts in a variety of manners including, but not limited to, an e-mail, a SMS, a prerecorded voice call, an Instant Message notification, a facsimile transmission, or the like.

In an exemplary embodiment, the insert 16 will include a data storage device which may include, but is not limited to, ROM, NVRAM, Flash memory, Disk drive or the like. The data storage device stores the configuration user interface program. This user interface may be HTML, Java, XML, or some proprietary program format. When the retailer logs into the machine, they will select their insert. The partitioned vending machine 10 will then read the configuration user interface program from the insert 16 and pass it along to the user. The user will then interact with the program (via a web browser or some other program) and submit. The input from the user is sent to the partitioned vending machine 10, which then passes it along to the insert 16. The insert 16 will then process the input and update its configuration accordingly. This configuration is then stored in data storage device of the insert 16. The partitioned vending machine 10 may also include a data storage device to store configuration information about the partitioned vending machine 10 (e.g., who owns what slot, user id's, network configuration) and logs for the vending machine (e.g., sales transactions and user logins).

In exemplary embodiments, the method of payment received by the partitioned vending machine 10 could further include a handheld device that could simply be pointed at an insert 16 and wirelessly access the insert 16. For example, a user may be able to use a BlueTooth™ enabled cellular phone to charge the purchase of an item to the user's cellular phone account. Allowing payment from a handheld device enables a very large number of the partitioned vending machines 10 to be hosted by a single central system.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A partitioned vending machine comprising:
a user interface portion for receiving an input from a user;
a insert for dispensing a product;
a plurality of compartments designed to receive the insert, each of the compartments associated with a difference retailer; and
a communications module for allowing communications with the partitioned vending machine.

2. The partitioned vending machine of claim 1, wherein the user interface portion further comprises:
a card reader;
a cash receiver/dispenser;
a keypad; and
a display.

3. The partitioned vending machine of claim 2, wherein the insert is configured to dispense a single large item.

4. The partitioned vending machine of claim 2, wherein the insert is configured to dispense a plurality of small items.

5. The partitioned vending machine of claim 2, wherein the insert is configured to dispense a book.

6. The partitioned vending machine of claim 2, wherein the insert is configured to dispense a compact disc.

7. The partitioned vending machine of claim 2, further comprising a web interface that allows a retailer to check an inventory of the product and to adjust a price of the product.

8. The partitioned vending machine of claim 2, wherein the card reader reads a retailer access card to provide access to the insert in the compartment associated with that retailer.

9. A partitioned vending machine comprising:
a user interface including:
a card reader;
a cash receiver/dispenser;
a keypad; and
a display;
a insert for dispensing a product;
a plurality of compartments designed to receive the insert; and
a communications module for allowing communications with the partitioned vending machine wherein the insert receives power from the partitioned vending machine.

10. The partitioned vending machine of claim 9, wherein the inset includes a cooling apparatus.

11. The partitioned vending machine of claim 9, further comprising a cooling apparatus that is used to selectively cool at least a portion of the plurality of compartments.

12. The partitioned vending machine of claim 9, wherein the card reader is operable for receiving a payment from a credit card, a debit card, or a gift card.

13. The partitioned vending machine of claim 12, wherein the keypad is operable for receiving a PIN number when the debit card is used for the payment.

14. The partitioned vending machine of claim 9, wherein the card reader reads a retailer access card to provide access to the insert in the compartment associated with that retailer.

15. The partitioned vending machine of claim 9, wherein the insert includes a data storage device for storing a configuration of the insert.

16. The partitioned vending machine of claim 9, wherein the partitioned vending machine is operable for receiving an electronic payment from a wireless device.

17. The partitioned vending machine of claim 16, wherein the wireless device is a cellular telephone.

18. A partitioned vending machine comprising:
a user interface including:
a card reader;
a cash receiver/dispenser;
a keypad; and
a display;
an insert for dispensing a product;
a plurality of compartments designed to receive the insert;
a cooling apparatus that is used to selectively cool at least a portion of the plurality of compartments; and
a communications module for allowing communications with the partitioned vending machine wherein the insert receives power from the partitioned vending machine, wherein:
the card reader is operable for receiving a payment from a credit card, a debit card, or a gift card;
the keypad is operable for receiving a PIN number when the debit card is used for the payment; and
the card reader reads a retailer access card to provide access to the insert in the compartment associated with that retailer.

19. The partitioned vending machine of claim 18, wherein the insert includes a data storage device for storing a configuration of the insert.
